(19) United States
(12) Patent Application Publication
(10) Pub. No.: US 2024/0251728 A1
(43) Pub. Date: Aug. 1, 2024

(54) METHOD AND APPARATUS FOR MEASURING EXPORT OF MACROALGAE OR AQUATIC BIOMASS AND SYSTEMS FOR CONFIRMING AND MONITORING CARBON REMOVALS CREDITS BASED ON MARINE BIOMASS

(71) Applicant: CLIMATE FOUNDATION, Seattle, WA (US)

(72) Inventors: Brian von HERZEN, Carson City, NV (US); Sam ZAK, Seattle, WA (US); Anna Wheatley LIEBOWITZ, Brooklyn, NY (US)

(73) Assignee: CLIMATE FOUNDATION, Seattle, WA (US)

(21) Appl. No.: 18/562,819

(22) PCT Filed: May 21, 2022
(86) PCT No.: PCT/US2022/030406

§ 371 Date: Nov. 20, 2023

Related U.S. Application Data
(60) Provisional application No. 63/191,505, filed on May 21, 2021.

(51) Int. Cl. A01G 33/00; A01D 33/00; A01D 33/02; A01D 44/02; A01H 13/00

(52) U.S. Cl. CPC A01G 33/00; A01D 33/02; A01D 44/02; A01H 13/00; A01D 2033/005

(57) ABSTRACT

Disclosed are a system and method for growing and/or monitoring macroalgae and aquatic plants in a large body of water. The method includes placing a mass or collection of the seaweed/aquatic plants in the body of water at a location where the water is at least 300 meters deep, and monitoring a depth of the seaweed/aquatic plants until the seaweed/aquatic plants sink below a sequestration threshold depth. The system includes a platform on or from which the seaweed or aquatic plants are grown, wireless detection equipment on the platform, and a wireless data signal transmitter on the platform, configured to transmit a wireless signal that indicates a depth of the sinking seaweed or aquatic plants.

### FIELD OF THE INVENTION

The present invention relates to systems for and methods of growing and harvesting aquatic plants and macroalgae, determining sequestration of aquatic biomasses, providing carbon credits (also known as carbon removals), and reducing the deleterious effects of climate change and ocean acidification.

### DISCUSSION OF THE BACKGROUND

Marine Permaculture (MP) platforms regenerate ocean life with permaculture design principles applied to marine environments, while developing high-value seaweed products and sequestering carbon (e.g., in the deep ocean). Across the tropics, warming waters increase ocean stratification, decreasing natural upwelling essential for primary production. As a result, seaweed forests are in steep decline in many tropical, sub-tropical and temperate waters, notably off the coasts of Tasmania and California, both of which have seen a decimation of their natural seaweed ecosystems and their associated marine life (Wernberg and Straub, 2016). Warming surface temperatures are also severely affecting smallholder seaweed farmers and their communities in southeast Asia, who have seen their yields plummet in recent years, with devastating consequences for coastal economies.

The decline of tropical seaweed forests is a concern for climate mitigation. Seaweeds have some of the highest carbon:phosphorus ratios and carbon fixation rates of any ecosystem on the planet, with rates of 2500-3000 g C/m²/year (Egan and Yarish, 1990; Mann 1972; Wu et al. 1984; Gao and Mckinley, 1994; Muraoka 2004; Buschmann et al., 2008) and act as important global carbon sinks that may be comparable to the Amazon rainforest (Krause-Jensen and Duarte, 2016; Duarte et al., 2022). The primary carbon sequestration function provided by macroalgae is their role as “carbon conveyors” that export particulate organic carbon (POC) and dissolved organic carbon (DOC) into the deep ocean for long-term storage. Duarte and Cebrian (1996) estimate that macroalgae ecosystems may export as much as 40% of their net primary production as particulate organic carbon and dissolved organic carbon; that is, biomass that is in addition to the standing stock of seaweed, comparable to leaves falling off a tree. This fact therefore means that cultivated macroalgae can sequester carbon dioxide in addition to providing biomass that can be harvested, as has been documented by a recent project led by the organization Oceans 2050. There is substantial evidence documenting the presence of seaweed in the deep ocean, including discovery of macroalgae DNA in ocean depths of 4,000 m and distances approaching 5,000 km from land (Ortega, et al., 2019), hypothesizing that globally macroalgae naturally export 173 TgC per year (Krause-Jensen and Duarte, 2016). Once sunk at a depth of between 300-1,000 meters, substantial oceanographic evidence shows that the carbon in macroalgae biomass will be removed from the atmospheric carbon cycle for centuries to millennia (Gebbie and Huybers, 2012; DeVries and Primeau, 2011), enabling it to qualify for long-term carbon sequestration.

FIG. 1 is a diagram showing how kelp forests fix and sequester carbon. Carbon dioxide from the air is absorbed or dissolved in the water, and is taken up by the kelp. The kelp is anchored to rocks on the sea/ocean bottom at depths of about 100 m or less. Air bladders in the kelp cause the anchored kelp to extend towards the surface. Some kelp may break off and form a window, which floats on the water and moves by Langmuir circulation. As the air bladders in the free-floating kelp burst (due perhaps to water pressure), the kelp sinks to the sea/ocean floor. Some anchored kelp may die or otherwise sink to the sea/ocean floor as well. Eventually, the kelp on the sea/ocean floor is either buried in the shelf (at a relatively shallow depth of, e.g., 100 m or less) or in the deep sea (e.g., at a depth of 1000 m or more).

FIG. 2 is a diagram showing carbon sequestration and the biological carbon pump. Due to gravity, certain forms of organic carbon naturally sink to the ocean/sea floor. Other forms may move to lower depths due to ocean mixing. Still others may be carried (e.g., by migrant animals, such as fish). Eventually, the organic carbon may be converted to CO₂, at which point it may move back to the surface. However, this movement of CO₂ back to the ocean surface takes some time. At depths of 100-300 m, it may take up to 10 years for the CO₂ to be released from the ocean due to its migration back to the surface of the water. At depths of 300-1000 m, such CO₂ release may take up to 100 years, and at depths >1000 m, such CO₂ release may take up to 1000 years. Thus, any forms of organic carbon (e.g., kelp, other macroalgae, or other aquatic flora) that are sequestered at a depth below 1000 m will be sequestered for well above 100 years, easily enabling it to qualify for long-term carbon sequestration.

Enhancing such natural processes by sinking macroalgae into the deep ocean, which currently holds 50 times more carbon than all the carbon in the atmosphere (Ontl and Schulte, 2012), represents a substantial and widely overlooked opportunity for carbon balance.

Small seaweed farmers are vulnerable to climate change. To illustrate, a marine heatwave in Indonesia in 2015 led to a 60% decline in production of seaweed, leading to the abandonment of 50% of seaweed farms. In the Philippines, typhoons are increasing in frequency and intensity, which can entirely wipe out seaweed crops. Lack of crop insurance means marine heatwaves can plunge farmers into poverty. Tropical seaweed farmers are therefore on the front lines of climate disruption, despite having done little to cause the problem. Furthermore, entire populations of nomadic fishermen have suffered from environmental decline and marginalization between multiple countries. However, the livelihoods of substantially all local coastal residents (but primarily seaweed farmers and fishermen) are at risk from impacts of warming water temperatures associated with climate disruption. Securing and climate-proofing their livelihoods thus concerns environmental justice.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### Glossary of Terms

The following section outlines and defines key terms.

DEEPWATER IRRIGATION refers to the processes of accessing deepwater nutrients from depth to facilitate macroalgae growth and encompasses both regenerative upwelling and deep cycling.

REGENERATIVE UPWELLING refers to mariculture and/or permaculture approaches that restore overturning circulation disrupted due to ocean warming by pumping cooler, deep water from below the thermocline to the surface to restore primary productivity and seaweed growth. Regenerative upwelling includes the upwelling of dissolved inorganic carbon which may be outgassed to the atmosphere, so this additional upwelled carbon should be considered in net carbon sequestration calculations, which can be done through reference to the Redfield ratio.

DEEP CYCLING refers to mariculture and/or permaculture approaches that lower and raise macroalgae platforms diurnally to enable seaweed growth. Platforms are lowered at night for access to nutrients and raised during the day for access to sunlight.

The present invention is applicable to all of the described approaches. It can also be applied to more conventional forms of seaweed mariculture that do not use deepwater irrigation.

### SUMMARY OF THE INVENTION

In various aspects, the present invention concerns a method of monitoring seaweed or aquatic plants sinking in a large body of water, comprising placing a mass or collection of the seaweed or aquatic plants in the body of water at a location where the body of water is at least 300 meters deep, and monitoring a flux of at least a portion of the mass or collection of the seaweed or aquatic plants (e.g., per area and per time interval) through a particular threshold depth (e.g., until the mass or collection of the seaweed or aquatic plants sinks below a threshold depth after which it will have a high likelihood to sink all the way to the seafloor and be sequestered there). The invention is applicable to both free-sinking seaweed biomass that falls off platforms naturally during growth, as well as seaweed that has been harvested and baled to be sunk for carbon export. The invention can be applied to various approaches to grow macroalgae in offshore environments, including MARINE PERMACULTURER (registered trademark of the Climate Foundation, Woods Hole, MA) deepwater irrigation approaches encompassing regenerative upwelling and diurnal deep cycling. In some embodiments, monitoring the flux of the mass or collection of the seaweed or aquatic plants comprises transmitting a sonar signal towards an expected location of the mass or collection of the seaweed or aquatic plants, and detecting a response or reflection signal from the mass or collection of the seaweed or aquatic plants. In the context of this patent, the term “sonar” may refer to any acoustic detection or transmission apparatus or method. For example, monitoring the depth of the mass or collection of the seaweed or aquatic plants may comprise monitoring the depth of the mass or collection of the seaweed or aquatic plants using side scan sonar.

In some embodiments, the mass or collection of the seaweed or aquatic plants has a mass or weight of one or more metric tons. In addition, the mass or collection of the seaweed or aquatic plants may be wet (e.g., containing 50% or more by weight of water) or dry (e.g., having a water content of 20% or less by weight). In other or further embodiments, the sequestration threshold depth is at least 300 meters (e.g., 500 meters) or at least 1,000 meters. The former value is sufficient to sequester the carbon in the seaweed or aquatic plant for a length of time on the order of one or more centuries. The latter value is sufficient to sequester the carbon in the seaweed or aquatic plant for a length of time on the order of one or more millennia.

Alternatively, monitoring the depth of the mass or collection of the seaweed or aquatic plants may comprise placing an acoustic or inductively coupled pulsed or AC transmitter, transponder or transducer on or near the mass or collection of the seaweed or aquatic plants or on a wire or rope (e.g., connected directly or indirectly to the mass or collection of the seaweed or aquatic plants) leading to a surface platform, transmitting (acoustic) pulses from the transmitter, transponder or transducer, and detecting one or more of the (acoustic) pulses. In some embodiments, the transmitter, transponder or transducer may be an acoustic pulsed time-division multiple access (TDMA) transmitter, transponder or transducer. In other or further embodiments, the transmitter, transponder or transducer may be placed on one or more bales of the seaweed or aquatic plant(s).

In some embodiments, the mass or collection of the seaweed or aquatic plants may comprise one or more bales. Accordingly, the method may further comprise baling or packaging the seaweed or aquatic plants prior to placing the bale(s) of seaweed or aquatic plants in the body of water. In some examples, the bale(s) of seaweed or aquatic plants may be aggregated or baled sufficiently tightly that the bale(s) of seaweed or aquatic plants sink at a rate of at least 1000 meters in no more than 48 hours, and likely faster.

In some embodiments, pulses from the transmitter, transponder or transducer are monitored for 4 hours to 8 days (or any length of time or range of time lengths therein) to confirm that the seaweed sinks below the threshold depth. Accordingly, in some examples, the transmitter, transponder or transducer is configured for high-pressure operation and/or includes a battery having a duration of 1-5 days, and the method may comprise providing power to the transmitter, transponder or transducer for at least 24 hours (e.g., from 1-5 days).

Further embodiments of the present method may further include logging the sinking and/or depth of the mass or collection of the seaweed or aquatic plants (e.g., determining and recording the depth, mass or flux of the seaweed/plant bale or mass in the body of water using the transmitter, transponder or transducer) into a blockchain record. For example, the depth of the mass or collection of the seaweed or aquatic plants may be determined and logged or recorded at intermittent or periodic time intervals, such as 1˜4 times per day for a length of time of at least 2 days. Optionally, the depth of the mass or collection of the seaweed or aquatic plants may be determined and logged or recorded for at most 5-10 days.

Further embodiments of the present invention may concern a method of harvesting and sequestering seaweed and/or aquatic plants, comprising harvesting the mass or collection of the seaweed or aquatic plants from the large body of water, prior to conducting the present method of monitoring seaweed or aquatic plants sinking in the large body of water. The large body of water may be an ocean, a gulf, a sea, a bay, or a lake having at least one location at which the water is typically at least 300 meters deep (e.g., having a depth of 300 meters, 500 meters, 1000 meters or more). The seaweed and/or aquatic plants may be harvested by collecting the seaweed or aquatic plants from the body of water and transporting the seaweed or aquatic plant to a platform using a first conveyor at least partially immersed in the body of water, and transporting the seaweed or aquatic plant from the platform to a deck or cargo hold of a vessel, such as a ship, barge or boat, using a second conveyor.

Further embodiments of the present invention may concern a method of growing, harvesting and sequestering seaweed and/or aquatic plants, comprising growing the seaweed and/or aquatic plants on a submerged or semi-submerged platform, frame or ring, then conducting the present method of harvesting and sequestering the seaweed or aquatic plants. Preferably, the seaweed or aquatic plants are grown to a mass or areal density of at least 5 kg/m² (e.g., 10 kg/m²) and/or in an amount of at least one metric ton (i.e., 1000 kg) prior to harvesting.

### BRIEF DESCRIPTION OF THE DRAWINGS

FIG. 1 is a diagram showing how kelp forests fix and sequester carbon, taken from Krause-Jensen and Duarte (2016), “Substantial role of macroalgae in marine carbon sequestration,” Nature Geoscience, 9(10), 737-742.

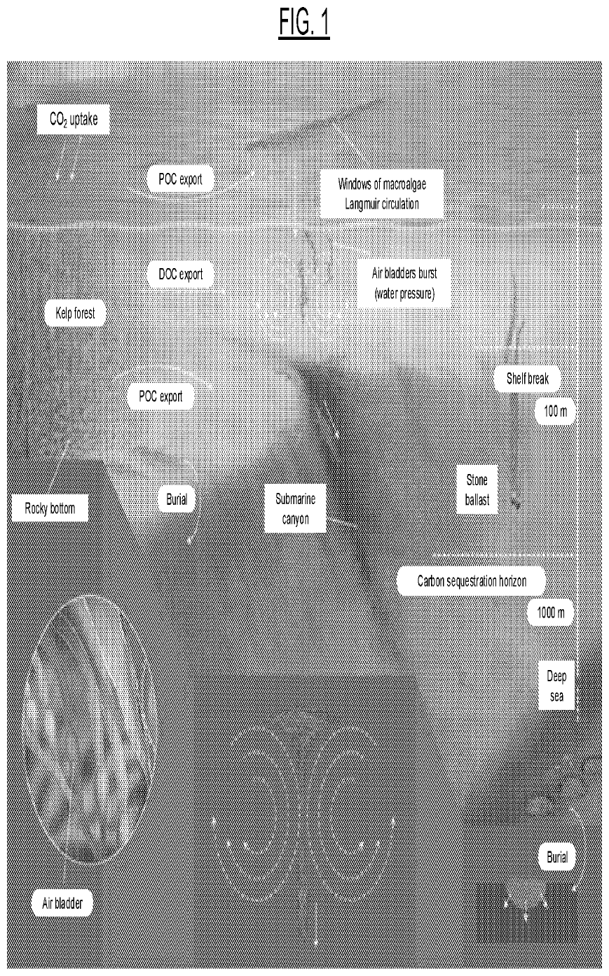

FIG. 2 is a diagram of the biological carbon pump and its sequestration time at different depths, taken from https://phys.org/news/2019-04-view-ocean-impact-climate.html.

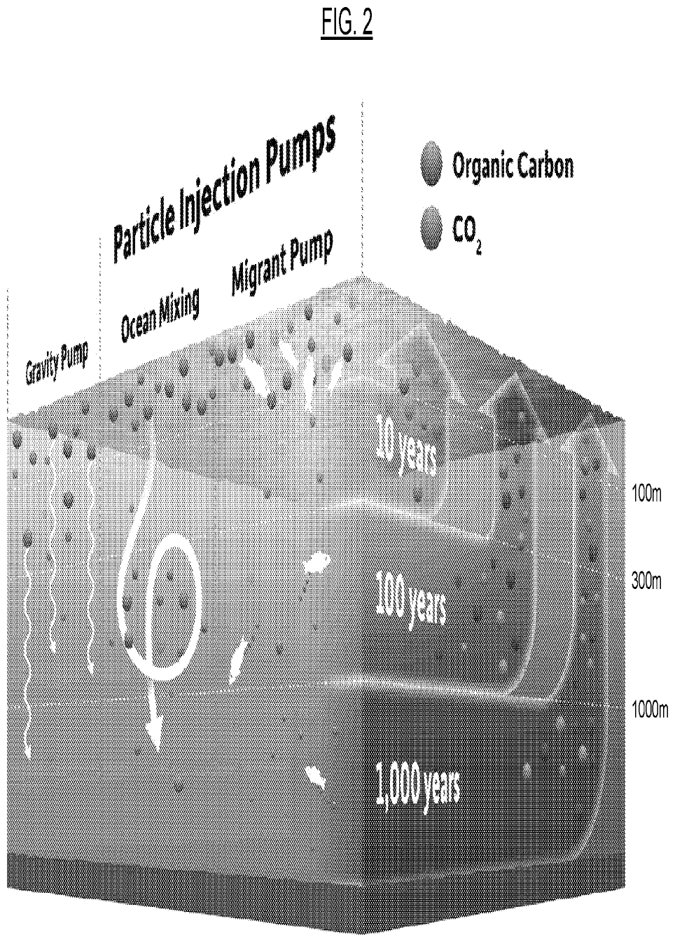

FIGS. 3A-D are photos of proof-of-concept deployments in relatively deep coastal waters in the Philippines, in accordance with one or more embodiments of the present invention.

FIGS. 4-5 are diagrams of exemplary 100 m² MP platforms, in accordance with one or more embodiments of the present invention.

FIG. 6 is a diagram of the 100 m² MP platform of FIG. 4 in accordance with one or more embodiments of the present invention.

FIG. 7 is a diagram showing an underwater view of the 100 m² MP platform of FIGS. 4 and 6.

FIG. 8 is a graph showing Apophis's spp. net weights with irrigation from surface water (orange, red and grey) and upwelled water (blue, green and yellow) between May 9 and May 27, 2020 from Climate Foundation trials in the Philippines.

FIG. 9A-B are photos of Kappaphycus alvarezii grown in MP trials in the Philippines.

FIG. 10 is a diagram of a MP platform monitoring the carbon export in accordance with one or more embodiments of the present invention.

FIG. 11 is a photo of an exemplary solar powered pump boat that can be used to transport seaweed in accordance with one or more embodiments of the present invention.

FIG. 12 is a table with data demonstrating the age of deep water as a function of water depth in the Marianas Trench, taken from Shan et al., 2020.

FIG. 13 is a flow diagram for carbon removal in accordance with one or more embodiments of the present invention, including carbon flows and sources of energy, feedstocks, and emissions.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

For the sake of convenience and simplicity, the terms “tube,” “pipe,” “conduit” and grammatical variations thereof are, in general, interchangeable and may be used interchangeably herein, but are generally given their art-recognized meanings. Wherever one such term is used, it also encompasses the other terms. Similarly, for convenience and simplicity, the terms “system” and “platform” may be used interchangeably herein. Wherever one such term is used, it also encompasses the other terms. Moreover, for convenience and simplicity, the terms “macroalgae”, “seaweed”, “aquatic biomass” and “aquatic plants” may be used interchangeably herein. Wherever one such term is used, it also encompasses the other terms. In addition, for convenience and simplicity, the terms “part,” “portion,” and “region” may be used interchangeably but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The present invention fixes and stores deep-ocean carbon over a relatively broad area (e.g., hundreds or thousands of km²) in relatively deep bodies of water (e.g., >1000 m deep), such as a sea or ocean. For example, the invention may operate in an area of 1-500 hectares and may provide deepwater irrigation services for a multi-hectare seaweed farming site in coastal waters and other natural bodies of water. The invention enables seaweed production at an increased yield, in comparison to conventional seaweed farming methods.

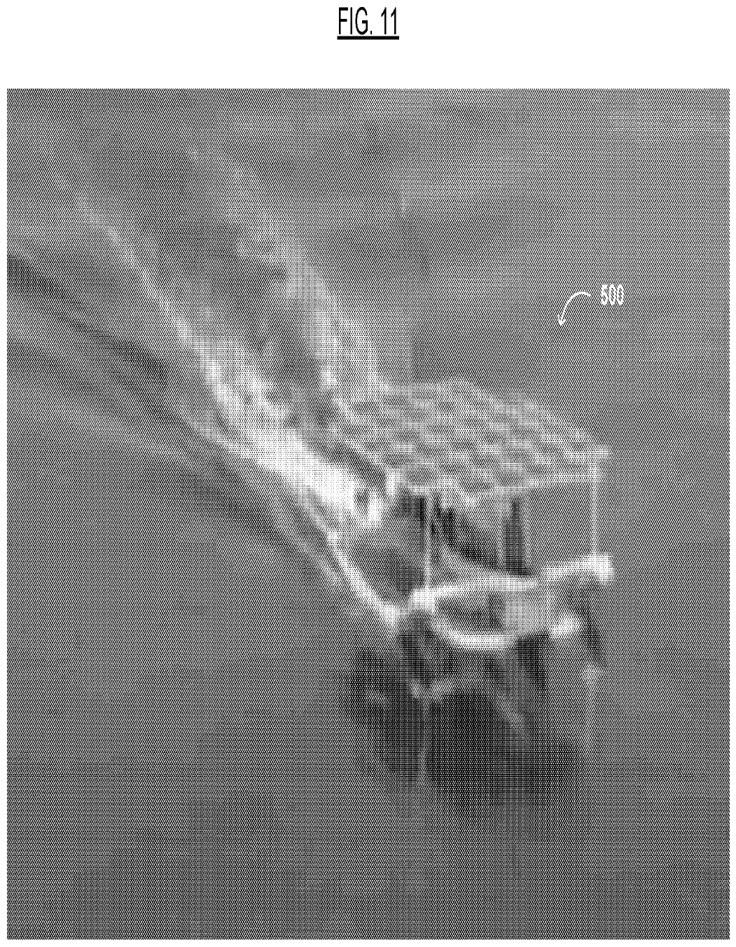

The invention can sink seaweed equivalent to a net sequestration of hundreds or thousands of metric tons of CO₂ at a price of several hundred US dollars (e.g., $400-800) per ton within a period of a few years. Harvesting the seaweed to generate high-value products while monitoring the biomass that falls off the seaweed naturally during growth may provide opportunities to sequester carbon at a negative cost; i.e. while turning a profit. The seaweed can be grown at multiple sites, and be towed with a solar powered pump boat (see the boat 500 in FIG. 11) to the deep ocean (e.g., the Bohol Sea, which has depths of over 1,000 m).

Sinking seaweeds to a depth of 300-1000 m or greater ensures its carbon will remain in place for hundreds of years before outcropping to the surface of the ocean in the Northeastern Pacific. A broad specified area can be used for sinking seaweed as carbon export to avoid putting all the carbon in one place on the seafloor, minimizing local impacts.

The species of seaweed can include kelps and other brown seaweeds like Sargassum spp., red seaweeds such as Eucheumatoid spp. (Eucheumatoids include Kappaphycus spp.) and even green seaweeds. Prior to sequestration, the C:P ratio for the seaweed will be determined; however, for the purposes of estimation, we can assume a C:P ratio of approximately 485:1, derived from a mean of red seaweeds taken from Rao and Indusekhar (1987). Thus, for regenerative upwelling architectures that rely on upwelling of deep water, for every 117 carbon atoms upwelled from relatively deep waters, approximately 485 will be fixed in the Eucheumatoid seaweeds that sink by themselves rapidly. The seaweed may sink past 1000 m depth in <48 hours, although this sinking can be accelerated by compactly baling the seaweed and adding biodegradable sandbags. The sinking of seaweed (in bales or in unbaled bunches or aggregations) can be monitored using side scan sonar. Adding acoustic transponders can increase the effective depth of monitoring if necessary. Monitoring the sinking to the sequestration horizon will be combined with radiocarbon dating of the deep ocean water's age to demonstrate the long-term sequestration of the carbon in the seaweed.

The invention demonstrates, for the first time, that regenerating deep-ocean carbon export and storage by growing and sinking macroalgae can serve as an economical and effective source of blue carbon sequestration and atmospheric carbon dioxide removal. The invention serves to effectively and logically demonstrate the potential of deep-ocean sequestration through macroalgae cultivation, partial harvesting and partial sinking or simply cultivation that measures natural export, and accelerates efforts to develop and accredit a deep-ocean macroalgae carbon export methodology, so that a number of nearshore and offshore seaweed farmers can engage in similar projects that use macroalgae as a source of carbon fixation, export and deepwater storage. Demonstrating the carbon removal capability of offshore macroalgae cultivation accelerates development of the seaweed-based carbon sequestration/capture industry and provides a revenue stream from corresponding carbon credits. Industry and certification bodies, such as Verra, the Australia Clean Energy Regulator, Gold Standard, Regen Networks and Nori can facilitate and certify the present and improving carbon capture methodologies.

### Exemplary Apparatuses and Methods for Growing Macroalgae and Aquatic Plants

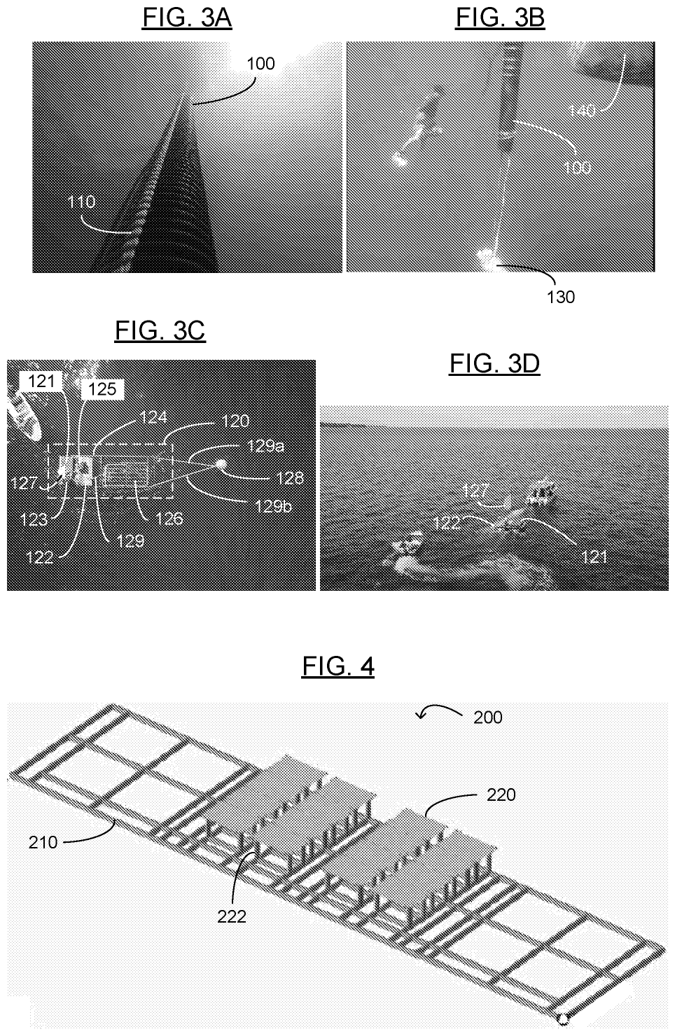

To mitigate against the impacts of warming waters on seaweed production, MARINE PERMACULTURER (registered trademark of the Climate Foundation, Woods Hole, MA; hereinafter, “MP”) platforms and deepwater irrigation systems have been developed. As described herein, multiple such architectures have been developed. FIGS. 3A-D are images showing an exemplary deployment of a small-scale MP system with regenerative upwelling. For example, FIG. 3A shows a corrugated pipe 100 adapted to bring relatively cool, nutrient-rich water from a depth of ˜30-50 m up to the surface, where the seaweed is located. A mooring line 110 runs along and is affixed to the corrugated pipe 100. The mooring line 11 is affixed to the platform 120 (FIG. 3C).

FIG. 3B shows an end of the upwelling pipe 100. Ballast 130 is attached to the upwelling pipe 100. A tether 140 comprising a one- or two-dimensional tensile manifold containing the seaweed is near the end of the upwelling pipe 100.

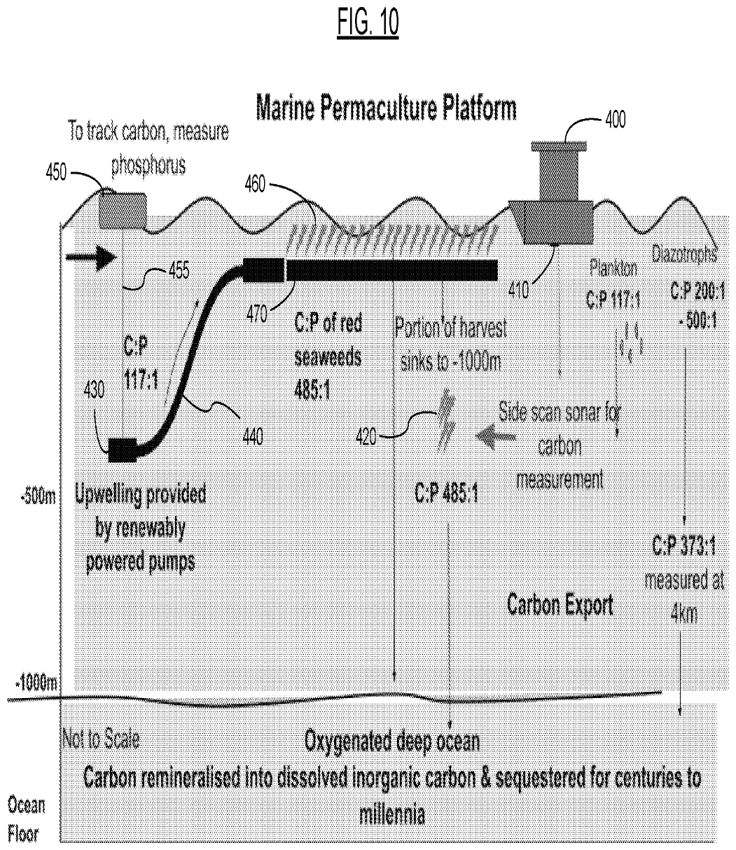

FIG. 3C shows an exemplary floating platform 120 from above. The platform 120 includes a deck 122, an outer frame 124, and an inner frame 126 to which the net 140 is attached. A solar panel 121, a pump 123, a box 125 and a flag 127 are on the deck 122. The solar panel 121 provides power for the pump 123, which may bring water up through the upwelling pipe 100. A hose 129 directs the upwelled water from the pump 123 into the inner frame 126 and the net 140. The box 125 may hold a battery (for storing electrical charge from the solar panel 121), various other electronics (e.g., a transmitter or transponder), or tools/equipment that may be useful in the MP system. In one embodiment, such a transmitter transmits data signals wirelessly documenting the submerged seaweed. The mooring line 110 may be attached to the deck 122 or to the buoy 128, which is, in turn, attached to the outer frame 124 by two lines 129a-b. FIG. 3D shows the deck 122 being towed by a boat 150. The deck 122 may be supported by one or more air bladders or pontoons (not shown). The platform may also comprise a submersible platform (e.g., on which the seaweed or aquatic plants are grown) and a surface platform, and a wireless transmitter or transceiver (see, e.g., the discussion of FIG. 10 below) may be on the surface platform or the submersible platform (which may optionally include additional equipment, as described herein).

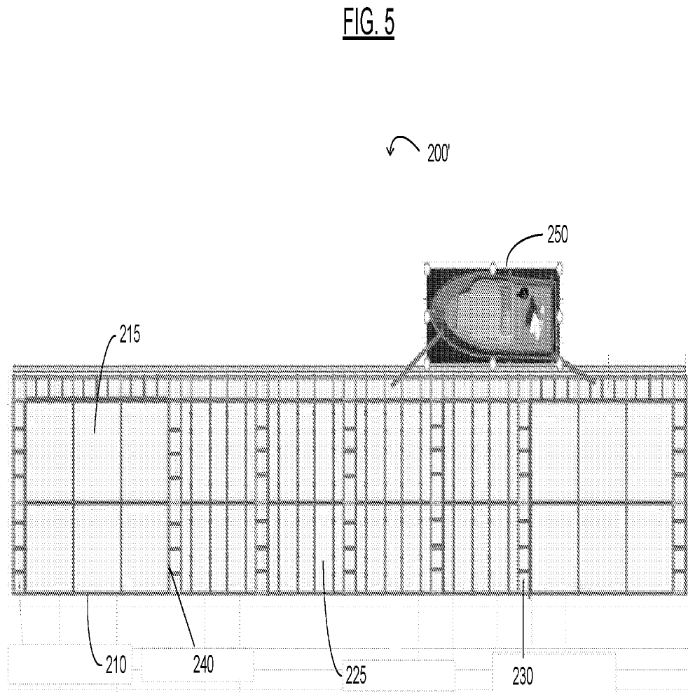

FIGS. 4-7 show exemplary larger-scale (e.g., 100 m²) MP platforms 200 and 200′ that comprises a frame 210 (e.g., made of high-density polyethylene [HDPE] pipes or tubes, joined together by one or more HDPE welding technologies) comprising a plurality of different sections (seaweed substrate) on or from which the seaweed or aquatic plant can be grown. The platform 200 may be supported by a plurality of air bladders or pontoons (not shown). The frame 210 may support one or more solar panels 220 using a plurality of support structures (e.g., vertical sections of pipe) 225. One or more nets or meshes (not shown) are attached to the frame 210, and macroalgae is grown on or in the net or mesh.

Typically, each solar panel 220 is supported by at least four support structures 222. The solar panels 220 may be transparent to light having a wavelength that is absorbed by the macroalgae or aquatic flora, but absorbs light having a different wavelength that is converted to electricity.

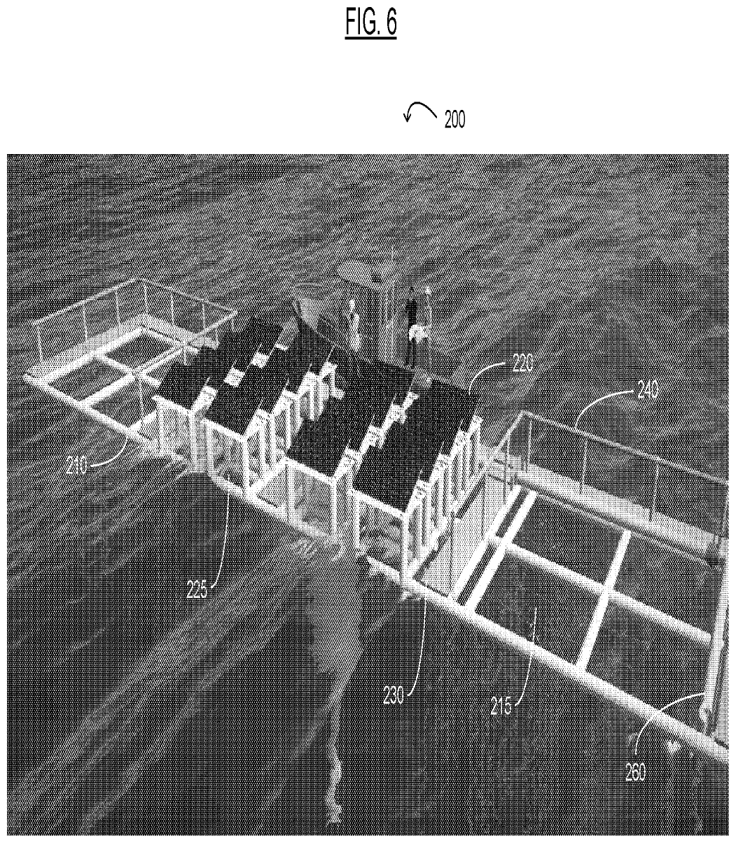

The frame 210 may include a set of first openings 215 and a set of second openings 225. Each of the first and second openings 215 and 225 are configured to support one or more arrays of macroalgae or aquatic flora. The first openings 215 as shown in FIG. 6 include six arrays, and the second openings 225 as shown in FIG. 6 include 2 arrays. The four vertical frame members in each of the second openings 225 support solar panels. The difference between the platform 200 in FIG. 4 and the platform 200′ in FIG. 5 is the number of second openings 225 (two in the platform 200 in FIG. 4, and four in the platform 200′ in FIG. 5). The arrays may independently have area (length and width) dimensions of from 1 m×1 m to 10 m×10 m, or any length and width within such ranges, although the invention is not necessarily limited to such dimensions.

Optionally, the platform 200/200′ may include a walkway 230 (FIG. 5) supported by the frame 210. The walkway 230 may have a width of 60-100 cm. The platform 200 may also include an optional handrail 240 along certain borders of the walkway 230. A boat 250 is moored to the platform 200′.

FIG. 6 shows the MP platform 200, including the solar panels 220 to generate electricity for electrically-powered devices, tools and/or components on board the platform 200, such as sensors or monitors, sonar detection equipment, one or more winches for cables or tethers to one or more anchors and/or one or more submerged platforms on which the seaweed or aquatic plants grow, one or more pumps for upwelling water from lower depths, one or more motors (e.g., for changing the angle of the solar panels or turning the platform so that the solar panels receive sunlight at a more orthogonal angle), etc. In this context, a winch may comprise a spool, windlass, capstan or other tension-providing and/or -holding device. Such a platform 200 also has a battery on board for storing electricity generated by the solar panels and one or more controllers or control systems to control electrical power generation and/or the electrically-powered devices, tools and/or components. Other platforms and systems for growing seaweed and aquatic plants, along with details of an exemplary controller and control system and various electrically-powered devices, tools and/or components for use on the platform can be found in U.S. Provisional Pat. Appl. No. 63/191,798, filed on May 21, 2021 (Atty. Docket No. CF-014-PR), and International Pat. Appl. No. PCT/US2022/______, filed contemporaneously herewith (Atty. Docket No. CF-014-WO), the relevant portions of which are incorporated herein by reference. In an alternate embodiment, wireless detection equipment comprises a camera taking images of a sampling frame with a net for capturing sinking seaweed and imaging the flux of seaweed being captured across the area of the sampling frame.

FIG. 6 shows first and second openings 215 and 225, from which the seaweed or aquatic plant can be grown. The walkway 230 and handrail 240 are more clearly shown, as is a cool water pipe 260 that supplies the relatively cool, nutrient-rich upwelled water to the macroalgae or aquatic flora just below the water surface.

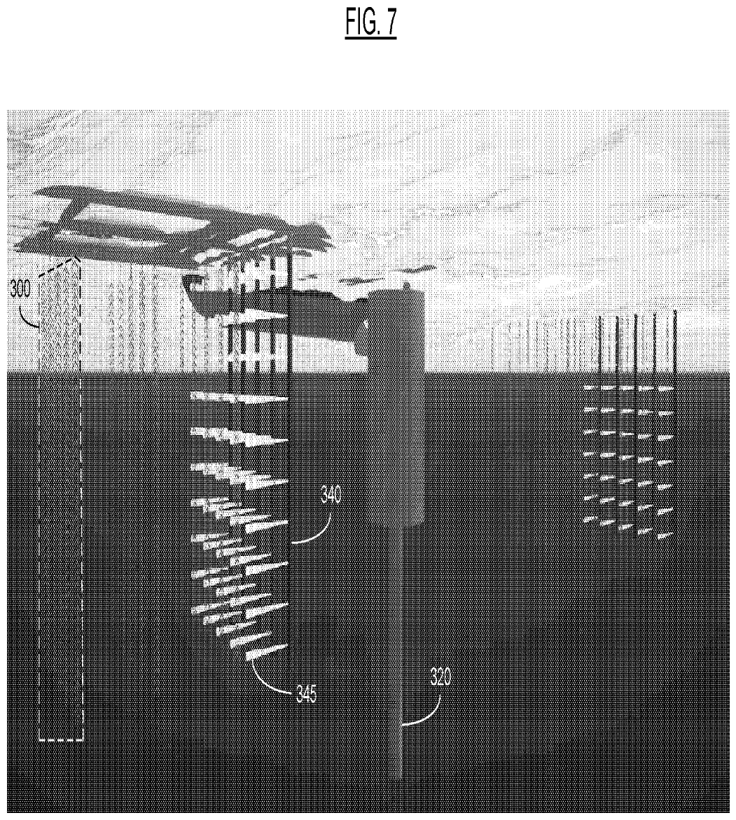

FIG. 7 shows the macroalgae arrays 300 and parts of a cool water circulation system below the platform 200/200′. The cool water circulation system includes an upwelling pipe 320, a pump 330, and a plurality of distribution pipes 340, each equipped with a plurality of distribution nozzles 345. The upwelling pipe 320 may be up to 50, 100, 200 m in length or more. The pipe 260 (FIG. 6) delivers the upwelled water to the distribution pipes 340 (FIG. 7). The macroalgae arrays 300 receive the upwelled water from the distribution nozzles 345.

MARINE PERMACULTURE (MP) apparatuses can restore natural upwelling of cool, nutrient-rich water from depths of, for example, 100-500 m using local renewable energy sources, such as wave energy or solar energy. This restoration is combined with an irrigation substrate on or from which seaweed can grow. Doing so can not only rescue production but can also extend the growing season and increase yields. Experimental trials in the Philippines have increased annual production of Eucheumatoids 2-4×especially during the difficult growing months while also improving crop quality, demonstrating the effectiveness of deep-water irrigation on seaweed growth.

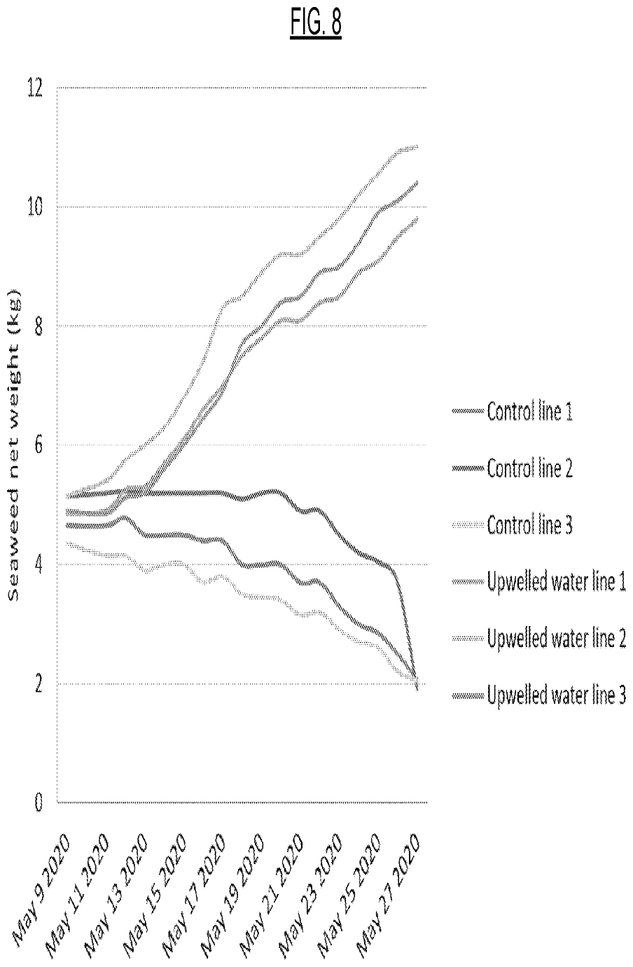

FIG. 8 compares the net weight of Eucheumatoids grown using an upwelling system similar to that shown in FIGS. 3A-C during May 2020. During the time frame shown in FIG. 8, the Eucheumatoids grown using upwelled water roughly doubled in weight, from ˜ 5 kg to ˜ 10-11 kg. By contrast, similar or identical Eucheumatoids grown in the same or similar nearby location without upwelled water (i.e., in the natural surface water) actually decreased in weight by ˜ 50%, from ˜ 4-5 kg to ˜ 2 kg.

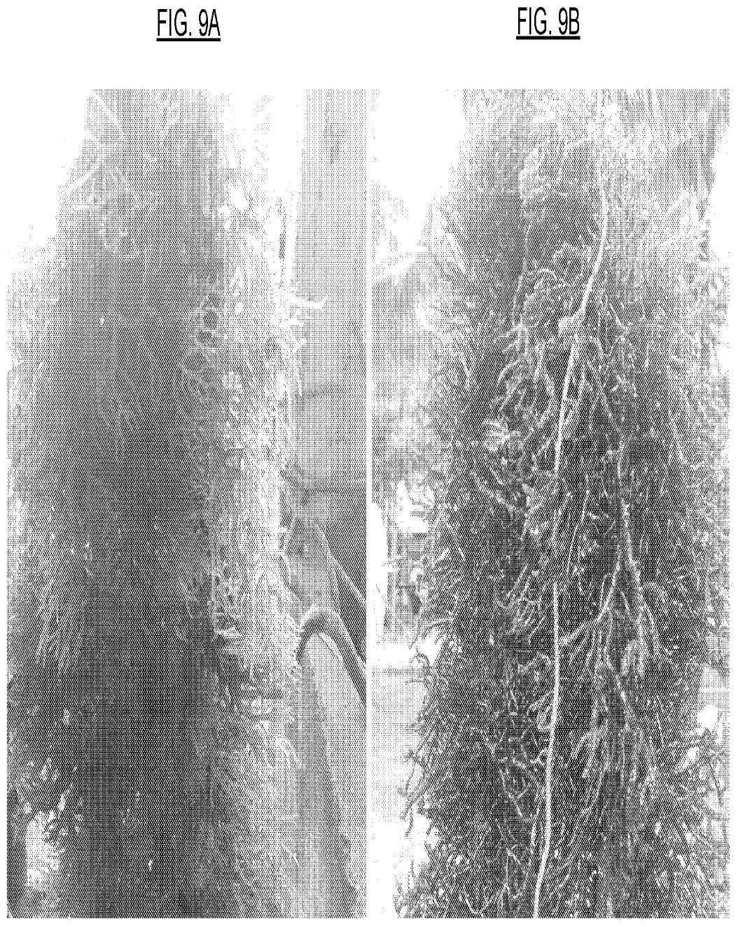

FIG. 9A shows growth of a strain of Kappaphycus alvarezii cultivated using traditional mariculture methods, and FIG. 9B shows the same strain grown from upwelling trough trials. The darker color and thicker stems in the Kappaphycus alvarezii shown in FIG. 9B indicate healthier and more carrageenan-rich seaweed.

MP irrigation can help seaweed farmers increase productivity and also provide resilience to marine heatwaves associated with climate disruption. MP deep-water irrigation systems and methods (see, e.g., International Patent Application No. PCT/US2021/16020, filed Feb. 1, 2021, the relevant portions of which are incorporated herein by reference) can dramatically increase the amount of cultivable ocean area by facilitating seaweed growth offshore. Examples of such deep-water irrigation systems and methods can be seen in FIGS. 3A-C and 7, which show a relatively wide tube (e.g., an HDPE or polypropylene [PP] tube or pipe having a diameter of 15-100 cm) extending substantially vertically into the water, to a depth of about 100 meters or more. Cooler water from deeper water may be upwelled (e.g., pumped) to the surface as needed or desired, to regulate the environmental temperature of the seaweed or aquatic plant and/or to bring nutrients to the surface from lower depths in the water. Given that nutrient limitations are key factors for seaweed growth, MP irrigation has enormous potential to scale across tropical and temperate waters.

### Exemplary Apparatuses and Methods for Growing and Sequestering Macroalgae and or Aquatic Plants

In further embodiments, a distributed network of square-kilometer-sized MP arrays that are managed by local coastal and island communities can be self-organized into cooperatives. A portion of the seaweed produced can be regularly harvested and processed in an at-sea biorefinery (see, e.g., U.S. Provisional Pat. Nos. 63/191,433 and 63/191,453, each of which was filed May 21, 2021 [Atty. Docket Nos. CF-005-PR and CF-006-PR, respectively], and International Pat. Appl. Nos. PCT/US2022/______ and PCT/US2022/______, filed contemporaneously herewith [Atty. Docket Nos. CF-005-WO and CF-006-WO), the relevant portions of each of which are incorporated herein by reference), from which high-value extracts for products such as nutraceuticals, hydrocolloids and bio-fertilizers can be generated. The residual seaweed can then be sunk overboard as a source of carbon export. Further carbon sequestration can be achieved by sinking additional seaweed as needed or desired. In the long-term, such a multi-use model may pioneer the concept of “carbon negative” products, as the carbon sequestered can more than offset emissions generated from seaweed products. Additional revenues can be generated from a sustainable harvest from fisheries sustained at least in part by an MP array.

It is estimated that open-ocean MP arrays covering merely 0.08% of oceans globally could sequester up to a gigatonne (1 million metric tons) of CO₂e each year, at costs ultimately below $100/metric ton. When accounting for potential profits derived from seaweed products created by the array (e.g., prior to sequestration), there is a potential to sequester carbon at a negative cost (profit).

FIG. 10 outlines the net carbon sequestration provided by an MP array. In order to measure the carbon export, levels of phosphorus in the water are tracked that serve as an indicator of the carbon content, as shown by the Redfield ratio of carbon to phosphorus (C:P). Conservatively, upwelled water has a C:P ratio of approximately 117:1. Most macroalgae have very high C:P ratios, ranging from 220:1 to 800:1. Although carbon will be upwelled from depths of 100-500 m or lower, the net intervention will be carbon negative, as the portion of the harvest that is sunk as carbon export has a much higher C:P ratio. Furthermore, plankton and diazotrophs (e.g., in the surface waters) fix any unused phosphorus and carbon in the upwelled water at or greater than the standard Redfield ratio, ensuring that the present system and methods are at least carbon neutral.

FIG. 10 shows an MP platform 400 with a sonar transponder or transceiver (or other wireless transmitter or transceiver) 410, capable of determining the depth of a package or bundle of seaweed 420. Relatively cool, nutrient-rich water is upwelled using a pump 430 and a pipe 440, as disclosed in International Pat. Appl. No. PCT/US2020/17253, filed Feb. 7, 2020, the relevant portions of which are incorporated herein by reference. The pump 430, which may be at a depth of ˜ 300-500 m, is moored to a buoy 450 using a mooring line 455. The buoy 450 may be moored to the MP platform 400 using a separate line or rope (not shown). The upwelled water is provided to the seaweed 460 through a distribution pipe 470.

The present invention thus also concerns a system for growing and sinking (sequestering) macroalgae (e.g., as carbon export), monitoring its sinking, and calculating its progress through deep ocean currents to verify long-term carbon sequestration timescales. Scaling and deployment of MP systems and methods across tropical to temperate seas can be accelerated with help from local seaweed farmer cooperatives. The system may include the present platform (e.g., on or from which the seaweed or aquatic plant is grown), sonar or other acoustic signal detection equipment on the platform, and a wireless data signal transmitter on the platform, configured to transmit a wireless signal that indicates a depth, mass or flux of the sinking macroalgae (or other aquatic flora). In further embodiments, the system may further include an acoustic or inductively coupled pulsed transmitter, transponder or transducer as described elsewhere herein, placed on, in or near the macroalgae or other aquatic flora (e.g., seaweed or aquatic plant[s]) or on a conductive wire or rope leading to the platform; a battery on the platform, configured to power the sonar detection equipment and the wireless data signal transmitter; one or more solar panels, wave energy, ocean thermal energy and/or wind energy harvesting devices, configured to generate electricity (e.g., to power other components on the platform and/or to be stored in the battery); a controller or control system on the platform, configured to control the power (1) from the solar panel(s) (e.g., to store in the battery or use in one or more on-board electrical devices) and, when present, the battery and (2) to the sonar detection equipment, the wireless data signal transmitter/transceiver, the battery and/or other electrical components or devices on the platform. For example, the other electrical components or devices may include one or more motors, as described herein; one or more winches, as described herein; one or more sensors (e.g., to determine weather conditions, sea roughness/wave height, water temperature, etc.); etc. Although the wireless data signal transmitter is typically part of a conventional wireless transceiver, wireless signal transmission as contemplated herein also includes transmission by inductive coupling on a conductive (e.g, metal) wire or rope. The wireless portion is the gap between the transmitter and the cable, conductive cable, steel rope or other tether. Such inductive coupling uses alternating current optionally comprising radio frequencies to couple electromagnetic radiation (i.e., signals) into the wire or rope. The inductively-coupled signals then propagate along the wire or rope, and are received inductively at a receiver. Inductively-coupled signal transmission and reception using a conductive wire or rope is considered herein to be a form of wireless communication. Other forms of wireless signal transmission and reception are also suitable for use in the present system.

Other components for the system for growing and sinking (sequestering) macroalgae (e.g., as carbon export), monitoring its sinking, and calculating its progress through the ocean (e.g., to a sequestration depth or greater) may include a net configured to catch, collect, bundle and/or aggregate seaweed as it falls from the platform (or near the platform) towards the ocean or sea depths (e.g., to collect a sample), and optionally a weight estimator comprising a mechanical scale and/or an artificial intelligence (AI)-based machine learning (neural network) tool that processes images to provide estimated weights of the seaweed captured in the net over time. Representative samples of this flux over a limited area can be used to derive robust estimates of the total flux coming off a wider area of platforms and can be compared with results from a nearby control site, thereby enabling tracking/monitoring the flux of seaweed per square meter per day below the submersible platform to the deep sea.

Regulatory constraints and governance issues can be a risk to projects aiming to use macroalgae for carbon sequestration, especially if it is perceived to be their sole purpose. Projects aiming to use macroalgae for carbon drawdown can ensure mariculture as the primary purpose, with carbon sequestration serving as an additional benefit, as can be done with MP platforms. MP is a form of mariculture. Such mariculture methods are exempt from the list of proscribed activities outlined in Annex 4 of Article 6b of the London Protocol, which is not in force at present. Given that MP methodology regenerates natural processes and provides ecological and economic benefits, it is anticipated that additional, larger trials will continue with considerable social support and acceptance.

Resilience in rough open-ocean conditions and extreme weather events have the potential to disrupt operation of the platforms and associated harvesting activities. The present mariculture platforms are being tested in deep waters nearshore prior to deployment in the open ocean. Marine solar technology is currently being tested successfully under Category 4 events. An exemplary MP array architecture may follow the same design considerations to build greater resilience into the present systems. Indeed, in December 2021, an offshore MARINE PERMACULTURE platform was at the epicenter of Super Typhoon Rai, a Category 5 Hurricane. By submerging the platform some meters beneath the surface, the platform survived intact, with seaweed still growing on it, demonstrating that such platforms and systems are resilient to the most extreme ocean conditions. There is a strong trend within the fish mariculture industry to move fish pens away from coastal locations, which may provide further positive synergy with MP platform development.

Carbon is removed for close to 1,000 years after it is sunk below 1,000 m into the ocean or other large body of water. Once sunk below the sequestration horizon (e.g., 1000 m), sequestration duration depends on ocean currents. Water masses in the ocean flow along isopycnal planes, and deep water in most of the oceans takes at least 1000 years to reach the surface. Thus, any carbon sequestered or dissolved in a deep-water mass will remain in that mass, and out of the atmosphere-surface ocean system, until the water mass is returned to the surface. Presumably, carbon in (but not dissolved in) the deep-water mass will remain in that mass, and out of the atmosphere-surface ocean system, for much longer.

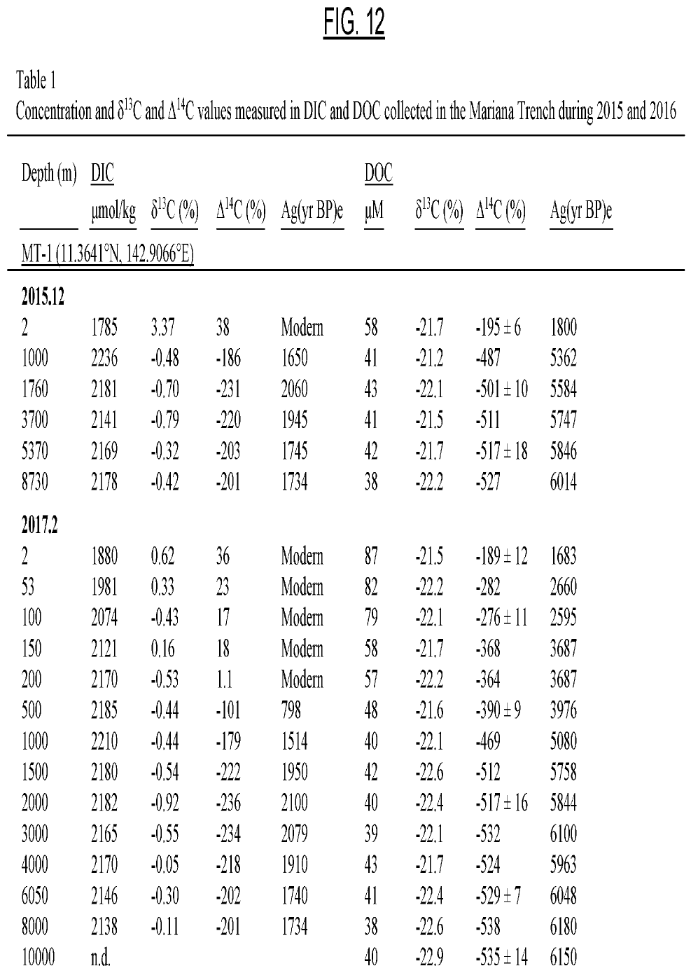

Maps of the age of ocean deep water masses, based on ¹⁴C dating and other techniques, can determine the length of time that carbon remains sequestered in various parts of the ocean and other large water bodies. Gebbie and Huybers (2011) have found that deep ocean water at a depth of 2500 m in the North Pacific can be no younger than 1100 years old. Furthermore, data from the Marianas Trench shows radiocarbon ages of >1000 years for all depths >1000 meters (Shan et al. 2020; see also FIG. 12).

At a minimum, a carbon storage term of 1000 years is expected based on the radiocarbon dates of water at 1000-6000 meters depth in the Western Pacific (Marianas Trench data). The maximum timescale for such deep-water outcropping to the surface is several thousand years, based on the maximum radiocarbon dates and the 4000-year timescale of the ocean conveyor.

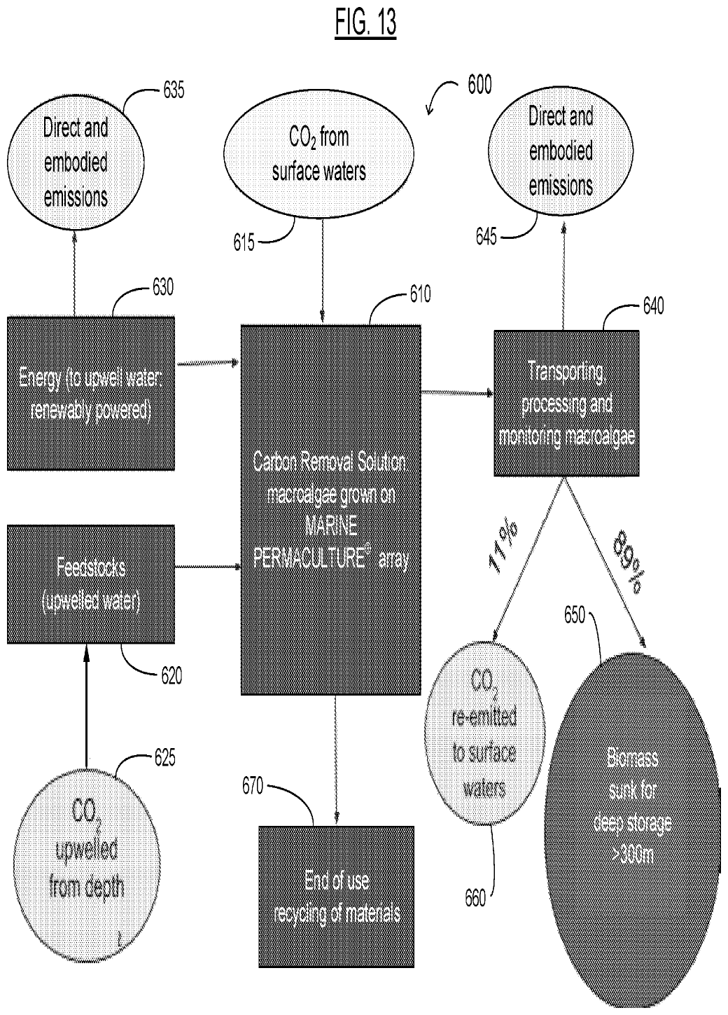

FIG. 13 shows a flow diagram 600 of the present method of growing and sequestering seaweed or other aquatic flora using upwelling of cooler, nutrient rich water, optionally monitoring the depth of the seaweed or aquatic flora as it sinks, and optionally using the sequestered seaweed or aquatic flora as a carbon credit. For example, a key part of the method is growing the macroalgae on an MP array at 610, as described herein. The macroalgae is grown using CO₂ in the surface waters (e.g., absorbed from the atmosphere) at 615 and a feedstock at 620 (e.g., CO₂ in water upwelled from a depth of 100-500 m, for example, at 625). Bringing the feedstock to the macroalgae may consume some energy at 630 (for example, to pump the upwelled water). In general, the energy consumed at 630 is renewable. For example, the energy can be solar- or wave-generated electricity, or a wave- or underwater current-powered pump (for transfer/upwelling of the feedstock; see, e.g., International Pat. Appl. No. PCT/US2020/17253, filed Feb. 7, 2020, the relevant portions of which are incorporated herein by reference).

Despite the use of renewable energy, there may still be some direct and some embodied emissions of CO₂ in this activity at 635. For example, upwelling of water from a depth of >100 m brings some CO₂ to the surface, where it may be released into the atmosphere. Also, in some models, when the energy is solar-based electricity, consumption of the electricity generates heat, which contributes to greenhouse effects, and manufacturing the solar panels causes some CO₂ and other greenhouse gases to be released into the atmosphere, although the solar panels are generally net carbon negative after some period of use.

After the macroalgae grow for a predetermined period of time or to a predetermined or desired size/mass, the macroalgae are harvested, then transported and/or processed at 640. The macroalgae may be transported by boat (e.g., the solar-powered boat 500 in FIG. 11) or ship, and may be processed at sea or on land. The macroalgae is then packaged or bundled in a manner so that it sinks (i.e., its density is greater than that of sea water, >1.03 kg/1), and it is released into deep water (e.g., >300 m [and preferably >1000 m] depth, into a sea or an ocean). As the macroalgae sink, it is monitored at 640 (e.g., using sonar, as described herein). In some embodiments, the method may further comprise placing a sonar transmitter, transponder or transducer (e.g., an acoustic pulsed transmitter, transponder or transducer) in or on the packaged/bundled macroalgae.

As is explained herein, the process of transporting, processing and sinking macroalgae results in some direct and embodied emissions of CO₂ at 645, such as from the energy-intensive transportation and processing activities themselves, even when using renewable energy. Losses of macroalgae during transportation and processing may lead to additional direct and embodied emissions. However, sinking the macroalgae-based biomass into deep water at 650 sequesters most (e.g., in many cases, about 89% or more) of the CO₂ brought in to the surface water from the atmosphere and from the upwelled water. It also leads to small re-emissions of CO₂ (about 11% or less; see the discussion below) at 660.

The present system and methodology rely on the well-documented biological pump, whereby the carbon content of ocean water increases with depth, due to the sinking of organic matter from the surface to greater depths. Once carbon sinks below 1000 m, it will flow with the water parcel until that water parcel moves along constant density surfaces and returns to the surface of the water body. Thus, it does not re-enter the atmospheric carbon cycle until the water mass surfaces. The median time to outcropping of the water to the surface approaches 1000 years in multiple locations (see Krause-Jensen and Duarte [2016]; Boyd et al. [2019]; Gebbie and Huybers, [2012]; DeVries and Primeau, [2011]; Matsumoto [2007]; and Shan et al. [2020]).

Biogeochemical analysis indicates that once carbon is sunk to the deep ocean (500-1000 m or deeper), it will remain at such depths until that water mass reaches the surface. The percentage of the seaweed at the water surface that successfully reaches the required depth (e.g., of >1000 m) is estimated at ≥90% if sunk loose (unbaled, but optionally aggregated) and >99% if the macroalgae is baled. The sinking speed of seaweed through the water column is estimated to be at least 500 m/day, although it is likely faster (Wernberg and Filbee-Dexter [2018]; Johnson and Richardson [1977]). Furthermore, it is believed that the sinking process can be enhanced by compactly baling the seaweed. Thus, the carbon export progress can be monitored with side scan sonar that tracks the seaweed sinking through the water column.

It is important that the actual permanence/durability of the carbon sequestered by the invention be quantified. The present approach is based on measurement of the macroalgae carbon export sinking through the water column combined with robust estimates of deep ocean currents and their outcropping time to determine carbon sequestration permanence.

Side scan (or other) sonar and other acoustic tracking technologies and telemetry can track seaweed sunk from the surface to ≥200 m below the surface to measure the quantity of seaweed reaching below the carbon sequestration export horizon. Once at the ocean floor, the macroalgae may be remineralized into dissolved or precipitated inorganic carbon.

Alternatively, a relatively low-power version of the sonar system may further include an acoustic or inductively coupled pulsed transmitter, transponder or transducer, placed on one or more bales of the seaweed, or in an unbaled ray, bunch or collection of seaweed, or on a conductive wire or rope connected directly or indirectly to the seaweed (e.g., leading to an aquatic vessel or surface platform). In some embodiments, the transmitter, transponder or transducer is an acoustic pulsed time-division multiple access (TDMA) transmitter. Including a transmitter with the seaweed reduces the acoustic power that the vessel-based sonar detector uses to image the seaweed. In various examples, the vessel is a boat, a ship, a multi-hulled vessel such as a catamaran, or a buoy. Thus, given a seaweed sinking rate of 300-500 m/day or more, pulses from the transmitter, transponder or transducer for some hours (e.g., 12-24) or days (e.g., 1-4) is sufficient to document the dropping or scuttling of the seaweed. Accordingly, in some examples, the transmitter, transponder or transducer includes a battery having a duration of 1-5 days. Embodiments that include such a transmitter, transponder or transducer reduce the cost of the on-board equipment, perhaps by orders of magnitude. In most embodiments, the acoustic pulse transmitter, transponder or transducer is configured for high-pressure operation. The detectability provided by the transmitter, transponder or transducer for the sinking seaweed is improved, given that sonar capability decreases as the fourth power of distance, whereas the ability to detect the acoustic transmitter pulse decreases only as the square of distance.

Embodiments relating to carbon sequestration-based carbon credits may further include logging over time (i.e., at intermittent or periodic time intervals, such as once per day for a length of time of at least 2-4 days and optionally at most 5-10 days) the sinking of the seaweed (e.g., as determined by the depth of the seaweed bale or mass in the body of water) using the transmitter, transponder or transducer into a blockchain record. Thus, information about the sequestration of the seaweed (which may be in units of one or more metric tons) thus becomes part of a permanent record. This digital permanent record enables tracking definitively the seaweed that is sunk or sequestered below 300 meters (e.g., 500 meters) or other acceptable depth for carbon sequestration (e.g., 1,000 meters) to ensure sequestration times of centuries or millennia, respectively.

Quantification of the long-term permanence of the carbon sequestration may be determined through reference to best-available science of deep-ocean mapping, showing radiocarbon ages. Location of the activity will be crucial to determining long-term sequestration, with some oceanic regions accommodating longer term sequestration than others. For instance, the northeasterly flow in the abyssal Pacific validates the multiple-century timescale of the carbon storage deeper than 300 m. Oceanographic evidence for the Pacific currents has confirmed this timescale at centuries, enabling it to qualify for long-term carbon sequestration. In fact, at depths below 1000 m, the sequestration times are expected to be similar to those measured in the Marianas trench, 1000-2000 years in those regions of the Pacific.

To a first approximation, each metric ton of dry seaweed (containing about 30% moisture) contains approximately one metric ton of CO₂e. Conservatively, each hectare of MP can grow 50 dry metric tons of biomass per year, based on the following. Macroalgae fixes up to 2500 grams of carbon/m²/year. With the typical carbohydrate makeup of commercial seaweeds, under replete environmental conditions, commercially relevant seaweeds may grow on the order of 60 metric tons of dry biomass per hectare (Ha) per year, corresponding to ˜90 metric tons at 33% moisture.

Independently, data on red seaweed growth in the Philippines has shown reproducible growth of 10 kg/m² wet mass during a growth cycle of 45 days, leading to 80 kg/m² wet seaweed mass per year. These growth rates correspond to 10 kg/m²/year of dry seaweed (i.e., with 0% moisture) and 100 dry metric tons of seaweed/Ha/year.

For each metric ton of seaweed that is sunk, a budget of up to 10% of the carbon may be estimated to be lost (e.g., in respiration). For example, if the seaweed is sunk as bales, 1% of the carbon is lost in the process of sinking. If sunk loose, about 10% of the carbon may be lost in sinking.

For regenerative upwelling approaches, carbon that is upwelled from relatively deep waters is also accounted for in FIG. 10. Assuming a seaweed carbon to phosphorus (C:P) ratio of 485:1, and a deep-water C:P ratio of 117:1, approximately 25% of the carbon that is fixed in the growing seaweed is from upwelled water. It is expected that 36-45% of the total carbon that is sequestered by the present method is offset by carbon released in the upper water. For each net metric ton of CO₂e sequestered, 1/(1-0.36)=1.56 gross metric tons of baled seaweed (CO₂e) should be sequestered or sunk, and 1/(1-0.45)=1.82 metric tons of loose seaweed (CO₂e) should be sequestered or sunk. To increase sinking efficiency and improve the ability to track sinking with side-scan sonar, the seaweed may be baled.

Terms for the amount of carbon upwelled with the deep-water and for the energy used to upwell water and to transport, refine, and sink seaweed were included in the above calculations. To the greatest extent possible, this energy will come from renewable sources. The Redfield C:P ratio is well known and documented. P is conserved since it does not go into the atmosphere. Published C:P ratios for red algae are used to approximate the C:P ratio of Eucheumatoids. All P not used for seaweed goes to making plankton at the same Redfield C:P ratio as the upwelled water (nominally a zero-sum game). Red seaweed has a C:P of 485:1, or 4 times higher than baseline Redfield ratio.

MP systems and methods restore year-round production of seaweed, increasing yields and revenues and securing livelihoods. The regenerative power of MP systems and methods ensures that food security for many people and ecosystem life support can be provided, while measuring the carbon drawdown of these regenerative interventions. Substantially, all local coastal residents can thus benefit from MP irrigation.

Lagrangian, self-guided MP systems and methods enable coastal communities to restore their livelihoods while retaining their cultural heritage and traditional lifestyles. The global expansion and modernization of the seaweed industry also raises concerns for environmental justice, as small-scale farmers risk disrupted livelihoods from falling crop prices from mechanization and scale-up of supply. MP systems and methods pioneer an alternative, distributed economic model for seaweed cultivation with inclusive value chains. It also shows that innovation within the regenerative blue economy can be community-driven from the bottom up.

Macroalgae beds and reefs have some of the highest carbon fixation rates of any ecosystem on the planet, approaching 2500-3000 g C/m²/year. These high carbon fixation rates, coupled with the fact that macroalgae require no nutrient inputs or freshwater inputs, makes it a uniquely efficient and sustainable form of biomass. The present method of sinking macroalgae biomass in the deep ocean is advantageous as it provides cost-effective, durable and reliable long-term carbon sequestration, as opposed to conventional biomass-based carbon stocks that are at risk from climate disruption. For example, wild fires through reforestation projects can release sequestered carbon back into the atmosphere.

MP systems and methods could be among the cheapest forms of biomass-based sequestration, with pathways to sequestering carbon at a negative cost if operations are combined with at-sea biorefineries that create high value seaweed products. Such products also have the potential to create additional carbon benefits by displacing fossil fuel-based alternatives. In this manner, it is unique among all solutions known to the present inventor. The present invention also provides local ecosystem services, such as mitigating ocean acidification, excess nutrient pollution and enhancing fish stocks.

One challenge for MP systems is to withstand rough ocean conditions when moved or placed offshore. Historic precedent is provided by commercial salmon aquaculture fish pens operating off the coast of Tasmania and Norway that use high density polyethylene (HDPE) hectare-scale structures such as offshore maricultural fish pens that have withstood 11-meter-high seas during Tasmanian winters, for example. Use of the same or similar HDPE materials in the present MP systems should enable them to be placed in open waters exposed to winter open-ocean storm conditions offshore. As described, MARINE PERMACULTURE® platforms and architectures have also been proven to withstand some of the harshest oceanic conditions.

Hectare-scale systems can be moored. For example, hectare-scale salmon aquaculture rings in Storm Bay of the Tasman Sea are exposed to winter swells from the Southern Ocean in excess of 10 meters amplitude. These are moored with an anchoring system, but it stretches the limits of the strongest 100 mm-diameter DYNEEMA (ultrahigh molecular weight and/or high modulus polyethylene) ropes. In the long term, remote, GPS-controlled guidance of MP platforms will enable greater and more cost-effective performance (see, e.g., U.S. Provisional Pat. Appl. No. 63/191,798, filed on May 21, 2021 [Atty. Docket No. CF-014-PR], and International Pat. Appl. No. PCT/US2022/______, filed contemporaneously herewith [Atty. Docket No. CF-014-WO], the relevant portions of which are incorporated herein by reference).

Seaweeds can be sunk over a broad, distributed area to eliminate deoxygenation of any particular seafloor region, thereby addressing relevant impacts of sinking seaweed in the environment. This process mimics the distribution of marine snow as plankton sinks to the deep ocean. To quantify and monitor the impact of MP activities, one may first establish baselines by measuring the oxygen and alkalinity levels of the water at multiple depths. Further (later) measurements can establish the impact of both seaweed growth and carbon sequestration. Samples for oxygen measurement may be taken and oxygen levels may be measured with conventional water sampling equipment. Such equipment may also measure micronutrient levels, phosphate levels, and nitrate levels.

Pre-existing and/or harmful algae blooms may be monitored upstream from the MP platform, and water quality may be monitored at relevant downstream sites. Remotely operated vehicles have been able to measure chlorophyll concentrations and wavelength(s) of harmful algae blooms (HABs). These vehicles are feasible for doing remote site monitoring upstream and downstream of MARINE PERMACULTURER sites.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims of any subsequent nonprovisional application that claims priority to the present application and their equivalents.

1. A method of monitoring seaweed or aquatic plants sinking in a large body of water, comprising
placing a mass or collection of the seaweed or aquatic plants in the body of water at a location where the body of water is at least 300 meters deep, and
monitoring a flux of at least a portion of the mass or collection of the seaweed or aquatic plants through a particular threshold depth.

2. The method of claim 1, wherein monitoring the flux of at least the portion of the mass or collection of the seaweed or aquatic plants comprises transmitting an acoustic signal towards an expected location of the mass or collection of the seaweed or aquatic plants, and detecting a response or reflection signal from the mass or collection of the seaweed or aquatic plants.

3. The method of claim 1, wherein the mass or collection of the seaweed or aquatic plants has a mass or weight of one or more metric tons.

4. The method of claim 1, wherein the threshold depth for sequestration is at least 300 meters.

5. The method of claim 1, wherein monitoring the flux of at least the portion of the mass or collection of the seaweed or aquatic plants comprises placing an acoustic or inductively coupled pulsed transmitter, transponder or transducer in, on or near the mass or collection of the seaweed or aquatic plants, or on a wire or rope connected directly or indirectly to the mass or collection of the seaweed or aquatic plants, transmitting pulses from the transmitter, transponder or transducer, and detecting one or more of the pulses.

6. The method of claim 5, further comprising monitoring the pulses from the pulsed transmitter, transponder or transducer for 4 hours to 8 days.

7. The method of claim 1, wherein the mass or collection of the seaweed or aquatic plants comprises one or more bales of the seaweed or aquatic plants.

8. The method of claim 1, further comprising baling or packaging the seaweed or aquatic plants prior to placing the bale(s) of seaweed or aquatic plants in the body of water.

9. The method of claim 1, wherein the bale(s) of seaweed or aquatic plants are aggregated or baled sufficiently tightly that the bale(s) of seaweed or aquatic plants sink at a rate of at least 1000 meters in no more than 48 hours.

10. The method of claim 1, further comprising logging the sinking and/or depth of the mass or collection of the seaweed or aquatic plants into a Blockchain record.

11. A method of harvesting and sequestering seaweed and/or aquatic plants, comprising:
harvesting the mass or collection of the seaweed or aquatic plants from the large body of water, then
conducting the method of claim 1.

12. The method of claim 11, wherein harvesting the mass or collection of the seaweed or aquatic plants comprises collecting the seaweed or aquatic plants from the body of water, transporting the seaweed or aquatic plant to a platform using a first conveyor at least partially immersed in the body of water, and transporting the seaweed or aquatic plant from the platform to a deck or cargo hold of a vessel using a second conveyor.

13. A method of growing, harvesting and sequestering seaweed and/or aquatic plants, comprising:
growing the seaweed and/or aquatic plants on a submerged or semi-submerged platform, frame or ring, then
conducting the method of claim 11.

14. The method of claim 13, wherein the seaweed or aquatic plants are grown to a mass or areal density of at least 5 kg/m² and/or in an amount of at least one metric ton prior to harvesting.

15. A system for growing, monitoring and sequestering macroalgae or aquatic plants, comprising:
a platform coupled to a seaweed-growing frame on or from which the seaweed or aquatic plants are grown,
wireless signal detection equipment, and
a wireless data signal transmitter, configured to transmit a wireless signal that is indicative of a depth, mass or flux of the sinking seaweed or aquatic plants.

16. The system of claim 15, further comprising an acoustic or inductively coupled pulsed transmitter, transponder or transducer, placed on or near the seaweed or aquatic plants or on a cable or rope leading to a surface platform.

17. The system of claim 16, further comprising:
a battery on the surface platform, configured to power the wireless detection equipment and the wireless data signal transmitter;
one or more renewable energy devices, configured to generate electricity; and
a controller or control system on the platform, configured to control the power (1) from the one or more renewable energy devices to the battery and (2) to the wireless detection equipment and the wireless data signal transmitter.

18. The system of claim 17, wherein the one or more renewable energy devices comprise one or more solar panels or one or more wave energy, ocean thermal energy and/or wind energy harvesting devices.

19. The system of claim 15, further comprising:
one or more winches; and
one or more motors, configured to operate the one or more winches.

20. The system of claim 15, further comprising one or more sensors configured to determine one or more weather conditions, a sea roughness and/or wave height, a water temperature, a depth, a pressure, or an amount or intensity of light.

21. The system of claim 15, further comprising:
a pipe configured to upwell water from a depth of at least 100 meters; and
a pump configured to transport the water through the pipe.

22. A system for harvesting and sequestering seaweed or aquatic plants in a large body of water, comprising the system of claim 15, and an aquatic vessel.

23. The system of claim 22, wherein the aquatic vessel is a boat, a ship, a multi-hulled vessel, or a buoy.

24. The system of claim 15, wherein the frame is configured to carry seaweed up and down from a depth of at least 50 meters.
